(19) United States
(12) Patent Application Publication
(10) Pub. No.: US 2019/0376632 A1
(43) Pub. Date: Dec. 12, 2019

(54) UNDER-PRESSURE TAPPING AND ACCESS ASSEMBLY FOR PRESSURIZED PIPE

(71) Applicant: Hydra-Stop LLC, Burr Ridge, IL (US)

(72) Inventors: Atticus D. Rush, Libertyville, IL (US); Christopher C. Vazzana, Palos Park, IL (US); Andrew J. Nelson, Chicago, IL (US); Cullen Geppert, Chicago, IL (US)

(73) Assignee: Hydra-Stop LLC, Burr Ridge, IL (US)

(21) Appl. No.: 16/425,444

(22) Filed: May 29, 2019

Related U.S. Application Data
(60) Provisional application No. 62/681,313, filed on Jun. 6, 2018.

(51) Int. Cl. F16L 41/04; F16K 27/06; F16L 29/00

(52) U.S. Cl. CPC F16L 41/04; F16L 29/002; F16K 27/06

(57) ABSTRACT

An under-pressure tapping and access assembly is provided for use with a pressurized pipe. The under-pressure tapping and access assembly includes a multi-branch portion sealingly coupled to an outer surface of the pressurized pipe. A tapping branch of the multi-branch portion extending along a tapping branch axis that is substantially perpendicular relative to a pipe axis of the pressurized pipe. A first access branch of the multi-branch portion extending along a first access branch axis that is non-perpendicular relative to the pipe axis. A tool is sized for insertion through the first access branch.

### TECHNICAL FIELD

This disclosure relates generally to a fitting for tapping a pressurized pipe or conduit. More specifically, this disclosure relates to a fitting including a valve that is installable on a pressurized pipe without shutting off flow to the pipe during installation. Still more specifically, this disclosure relates to a fitting that allows access for a tool to be inserted into the pressurized pipe.

### BACKGROUND

Pressurized conduits or pipes convey fluids, both liquid and gas, in municipalities, industrial plants and commercial installations. When originally installed, a network of pipes may include block valves used to isolate certain sections of the pipe for repairs, relocation or installation of new components into the pipe. The network of pipes, however, may not typically provide access for tools, such as inspection equipment, to be inserted into an interior portion of the pipe while the fluid in the pipe remains pressurized. Rather, fluid flow may need to be blocked or otherwise shut down in the portion of pipe to be accessed.

Certain tools, such as pushrod camera systems, may be used to inspect the pipe. Such tools, however, may not be easily inserted into the pipe while pressurized. Furthermore, current under pressure pipe inspection methods may not be compatible with pipes having a diameter of four inches or less. The smaller dimensions of these pipes may increase the difficulty of inserting and properly positioning the tools within the interior portion of the pipe.

Additionally, some tools may include a tether that is used to mechanically secure the tool, carry communication lines, or transmit power for control signals, camera feeds, or other types of information. As the tool traverses the pressurized pipe, the tether is extended or retracted. Sharp edges within the pipe, whether pre-existing or created during hot-tapping, may damage the tether, resulting in lost tools, decreased functionality, and repair expenses.

### SUMMARY

In keeping with an embodiment of the present disclosure, an under-pressure tapping and access assembly is provided for use with a pressurized pipe. The under-pressure tapping and access assembly includes a multi-branch portion sealingly coupled to an outer surface of the pressurized pipe. A tapping branch of the multi-branch portion extending along a tapping branch axis that is substantially perpendicular relative to a pipe axis of the pressurized pipe. A first access branch of the multi-branch portion extending along a first access branch axis that is non-perpendicular relative to the pipe axis. A tool is sized for insertion through the first access branch.

In keeping with another embodiment of the present disclosure, a kit is provided for accessing and monitoring a fluid within a pressurized pipe. The kit includes an under-pressure tapping and access assembly having a multi-branch portion sealingly coupled to an outer surface of the pressurized pipe, a tapping branch of the multi-branch portion extending along a tapping branch axis that is substantially perpendicular relative to a pipe axis of the pressurized pipe, and a first access branch of the multi-branch portion extending along a first access branch axis that is non-perpendicular relative to the pipe axis. The kit also includes a first valve coupled to the tapping branch, a second valve coupled to the first access branch, and a tool sized for insertion into the pressurized pipe via the second valve and the first access branch.

In keeping with another embodiment of the present disclosure, a method is provided of tapping and accessing a pressurized pipe. The method includes attaching a multi-branch fitting to a section of the pressurized pipe, the multi-branch fitting including a tapping branch extending along a tapping branch axis that is substantially perpendicular to a pipe axis of the pressurized pipe, and a first access branch extending along a first access branch axis that is non-perpendicular relative to the pipe axis. Next, the pressurized pipe is hot-tapped via the tapping branch, and a tool is inserted into the pressurized pipe via the first access branch.

### BRIEF DESCRIPTION OF THE DRAWINGS

For a more complete understanding of the disclosed methods and apparatuses, reference should not be made to the embodiments illustrated in greater detail in the accompanying drawings, wherein:

FIG. 1 is a cross-sectional view of an under-pressure tapping and access assembly installed on a section of cylindrical pipe, in accordance with an embodiment of the present disclosure.

FIG. 2 is a perspective view of the under-pressure tapping and access assembly of FIG. 1, in accordance with an embodiment of the present disclosure.

FIG. 3 is a perspective view of an alternative embodiment of an under-pressure tapping and access assembly installed on a section of pipe.

FIG. 4 is a side elevation view, in cross-section, of the under-pressure tapping and access assembly of FIG. 3.

FIG. 5 is a perspective view, in partial cross-section, of a further embodiment of an under-pressure tapping and access assembly including a guide assembly.

FIG. 6 is an enlarged perspective view of the guide assembly of FIG. 5.

FIG. 7 is an enlarged perspective view of a yoke of the guide assembly of FIGS. 5 and 6.

FIG. 8 is a block diagram of a method of tapping and accessing a pressurized pipe, in accordance with an embodiment of the present disclosure

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments herein.

### DETAILED DESCRIPTION

Examples of multi-branch access fittings are disclosed herein that facilitate tapping and insertion of tools into pressurized pipes. The multi-branch fittings include a tapping branch at an orientation relative to the pipe that permits a hot-tapping procedure to be performed. Additionally, the multi-branch fittings include at least one access branch at an orientation relative to the pipe that permits tools to be inserted more easily into the pipe. In some embodiments, a tether guide is provided to hold a tether coupled to the tool away from sharp edges formed in the pipe.

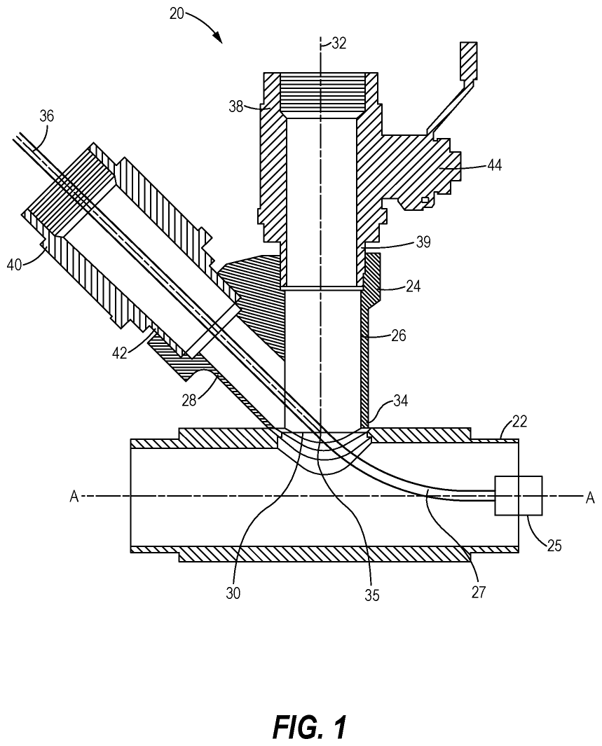

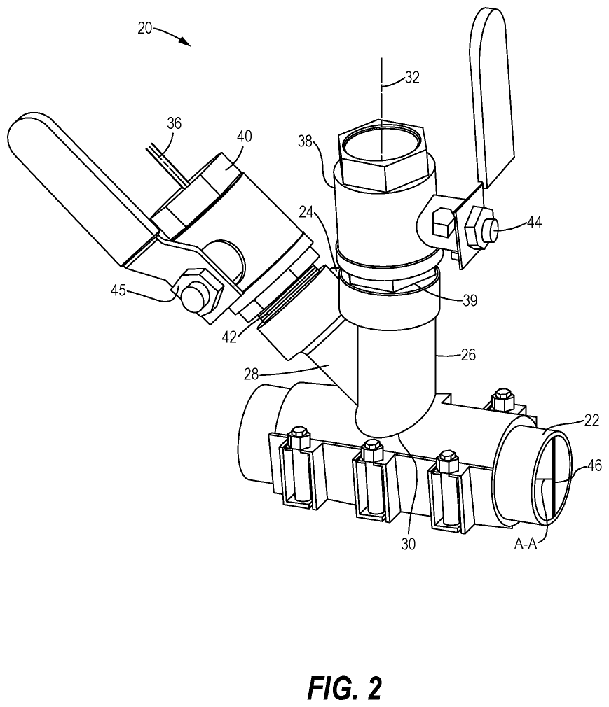

An example of an under-pressure tapping and access fitting 20 is shown in FIGS. 1 and 2 mounted to a section of a pipe 22. The pipe 22 may be a pressurized pipe or conduit, such as a municipal water main. Other applications will be apparent to those skilled in the art and this disclosure in no way is limited to municipal water applications. Those skilled in the art will be aware of other industrial and commercial needs for installing a tapping and access fitting in a pressurized pipe or conduit without depressurizing the pipe or conduit.

Still referring to FIGS. 1-2, the under-pressure tapping and access fitting 20 may be coupled or otherwise sealingly attached to the section of pipe 22 using bolts, clamps, gasket mat, and/or other such attachment components. Additionally, the under-pressure tapping and access fitting 20 may include a multi-branch portion 24 that extends away from an exterior surface of the section of pipe 22. In this example, the multi-branch portion 24 includes two branches, namely a tapping branch 26 and a first access branch 28, oriented in a Y-shape configuration. The tapping branch 26 and the first access branch 28 of the multi-branch portion 24 may align with a tapping hole 30 cut or otherwise created to extend through an outer surface and into an interior of the section of pipe 22.

The tapping branch 26 is oriented relative to the pipe 22 to facilitate a hot-tapping procedure. Accordingly, the tapping branch 26 extends along a tapping branch axis 32 that is substantially perpendicular (i.e., within manufacturing tolerances) with respect to a pipe axis A-A. As such, the tapping branch axis 32 may define a substantially 90 degree angle (i.e., within manufacturing tolerances) with an apex 34 of the section of pipe 22. The apex 34 may coincide with a center 35 of the tapping hole 30 cut or otherwise created in the section of pipe 22. In some embodiments, the multi-branch portion 24 is configured such that the perpendicular orientation of the tapping branch axis 32 allows for the use of standard tapping equipment to cut or otherwise create the tapping hole 30 substantially perpendicular to the pipe axis A-A.

In a hot-tapping procedure, a new access point into the pipe is formed while the fluid inside the pipe remains at an operable pressure. For example, commonly assigned U.S. Pat. Nos. 8,627,843 and 9,644,779 disclose methods of installing additional gate valves in pressurized pipes that do not require service interruption and result in minimal fluid or pressure loss. The additional gate valves connect to the pipe as an assembly using a permanent housing known as a valve housing that is sealably clamped, welded, or otherwise sealably joined to the pipe and normally extends upward. A temporary gate valve is sealably mounted on the open top of the valve housing (i.e., the distal end of the valve housing). One or more “tap” or installation housings and a tapping machine are mounted on top (distal end) of the temporary gate valve for delivering a cutting device through the temporary gate valve to the proximal end of the valve housing to cut out a hole or “coupon” in the exposed pipe. After removal of the cutting device and closure of the temporary gate valve, the same or similar installation housings are mounted on the distal end of the temporary gate valve for delivering the gate valve cartridge through the temporary gate valve and to the interior of the valve housing, where it is housed while in the open position. This procedure is accomplished without depressurizing the pipe. Hot-tapping of smaller diameter pipes is similar to the process described above, however a smaller, hand-held drill may be used to create the access point in the existing pipe, as described in greater detail in U.S. Patent Application Publication No. 2007/0297867, the contents of which are herein incorporated by reference.

The first access branch 28 is oriented relative to the pipe 22 to facilitate insertion of a tool 25, such as an inspection probe, maintenance tool, or other device configured to inspect, measure, obtain dimensions, repair, clean, or perform other down-pipe operations, into the pipe 22. Accordingly, the first access branch 28 extends along a first access branch axis 36 that is substantially non-perpendicular (i.e., within manufacturing tolerances) with respect to the pipe axis A-A. In one non-limiting example illustrated in FIG. 1, the first access branch axis 36 defines a substantially 45 degree angle (i.e., within manufacturing tolerances) with the apex 34 of the tapping hole 30 created in the section of pipe 22. As such, the tapping branch axis 32 and the first access branch axis 36 may intersect at the apex 34 of the section of pipe 22, which also may coincide with the center 35 of the tapping hole 30. While the first access branch axis 36 as shown defines a 45 degree angle with the apex 34, it will be understood that the first access branch 28 may be configured to define or otherwise form other non-perpendicular angles with the apex 34 of the section of pipe 22.

The multi-branch portion 24 further may be configured for attaching additional components of the tapping and access fitting 20. For example, the tapping branch 26 may be threaded to receive a first NPT portion 38 having an NPT threaded portion 39. Similarly, the first access branch 28 may be threaded to receive a second NPT portion 40 having an NPT threaded portion 42. The NPT threaded portions 39, 42 may be sized to allow first and second valves 44, 45 to be coupled to the tapping branch 26 and first access branch 28, respectively, of the multi-branch portion 24. Each of the first and second valves 44, 45 may be a nipple valve, a ball valve, or other such valve configured to retain pressure within the section of pipe 22 during tapping and subsequent tool access.

FIG. 2 further illustrates a diameter 46 of the section of pipe 22. In an embodiment, the under-pressure tapping and access fitting 20 is used on a section of pipe 22 having a diameter of 4 inches or less. Such pipe may be used in a variety of locations and applications, including but not limited to, service lines, fire suppression lines, industrial cooling lines and the like. Furthermore, it will be understood that the under-pressure tapping and access fitting 20 may be configured to be used on a section of pipe 22 having a different diameter (e.g., larger than 4 inches).

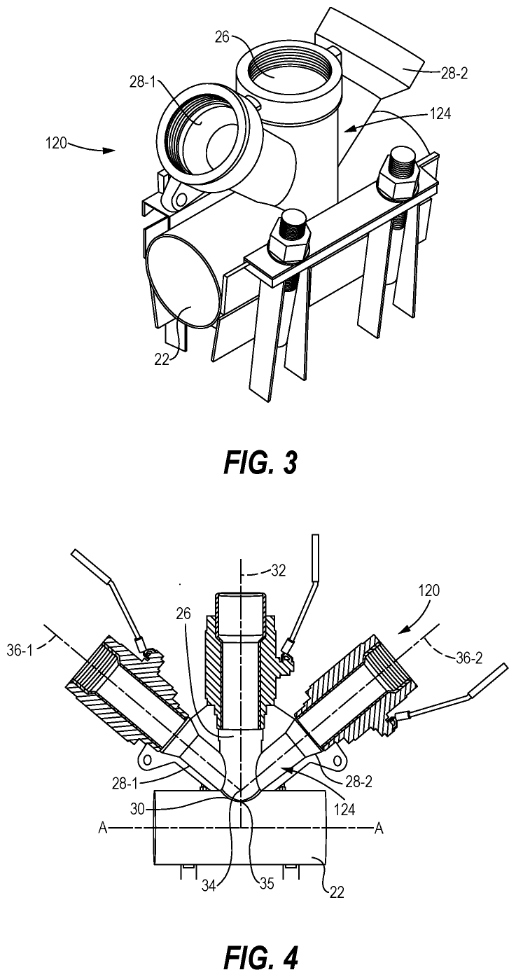

In an alternative embodiment illustrated at FIGS. 3 and 4, an under-pressure tapping and access fitting 120 includes first and second access branches 28-1 and 28-2. Specifically, the under-pressure tapping and access fitting 120 includes a multi-branch portion 124 including a tapping branch 26, a first access branch 28-1, and a second access branch 28-2 oriented in a W-shape configuration. The tapping branch 26 extends along tapping branch axis 32 that is substantially perpendicular (i.e., within manufacturing tolerances) with respect to pipe axis A-A. Each of the first and second access branches 28-1, 28-2 extends along a non-perpendicular axis with respect to the pipe axis A-A. The first and second access branches 28-1, 28-2 may be symmetrically or otherwise positioned around the tapping branch 26 such that the centerline of each of a first access branch axis 36-1 and a second access branch axis 36-2 intersects with the centerline of the tapping branch axis 32 of the tapping branch 26 at the apex 34 of the section of pipe 22. Accordingly, the intersection of the tapping branch axis 32 and plurality of first and second access branch axes 36-1, 36-2 may coincide with the center 35 of the tapping hole 30.

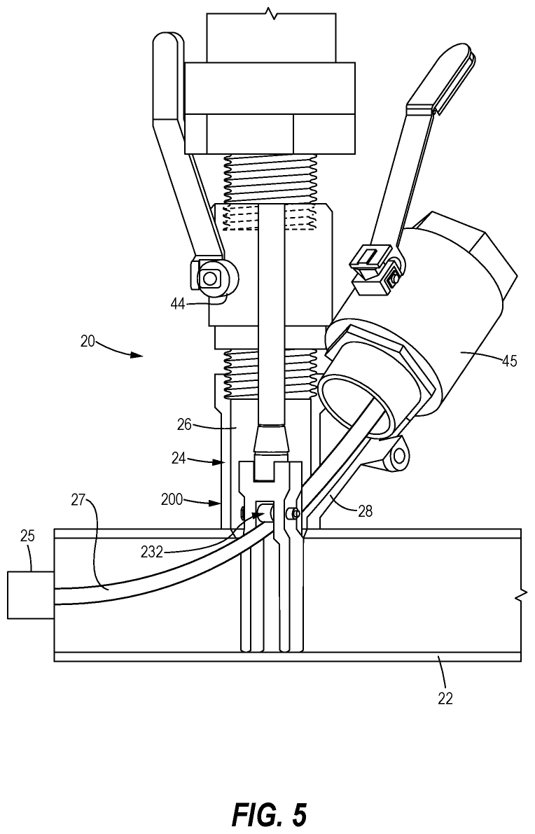

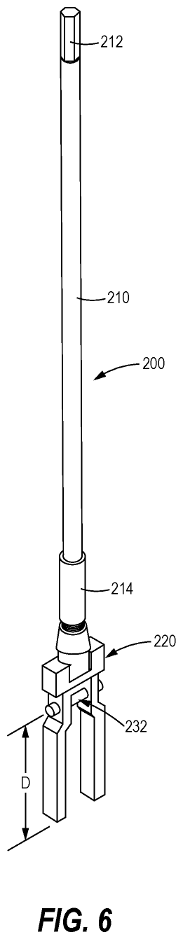

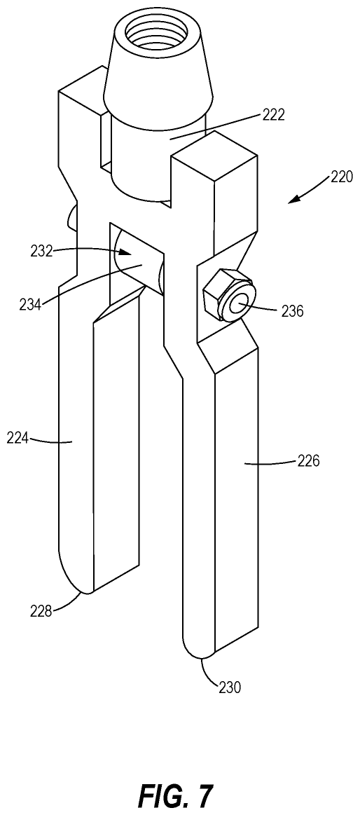

In a further embodiment illustrated at FIGS. 5-7, the under-pressure tapping and access fitting 20 further includes a tether guide assembly 200 for holding a tether 27, attached to the tool 25, away from sharp edges inside the pipe 22. The tether guide assembly 200 generally includes an insertion rod 210 and a yoke 220. The insertion rod 210 is sufficiently long for insertion through the tapping branch 26 of the multi-branch portion 24, and includes a proximal end 212 and a distal end 214. The yoke 220 is coupled to the distal end 214 of the insertion rod 210 and is sized to pass through the tapping branch 26 and into the pipe 22. The yoke 220 includes a base 222 and two spaced tines 224, 226. The tines 224, 226 define tine ends 228, 230 that engage an inner surface of the pipe 22 when the yoke 220 is fully deployed. A guide 232 extends between the tines 224, 226. The guide 232 is spaced from the tine ends 228, 230 by a distance D so that a bottom of the guide 232 is positioned adjacent the apex 34 of the tapping hole 30. when the tine ends 228, 230 engage the inner surface of the pipe 22. Accordingly, the guide 232 ensures that the tether 27 remains spaced from sharp edges of the tapping hole 30. In some examples, the guide 232 may include a roller 234 rotatably supported on an axle 236 to permit rotation of the guide 232, thereby to reduce friction resisting movement of the tether 27 as the tool 25 is deployed into or withdrawn from the pipe 22.

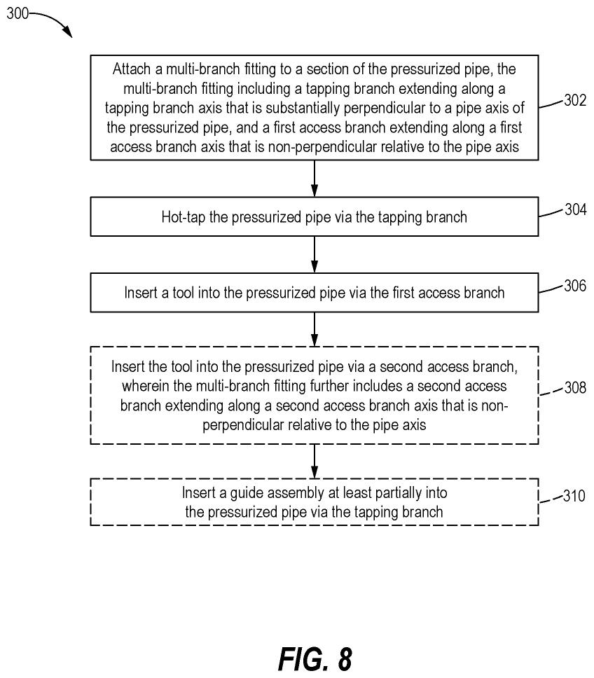

FIG. 8 is a block diagram illustrating a method 300 of tapping and accessing a pressurized pipe. The method includes, at block 302, attaching a multi-branch fitting to a section of the pressurized pipe. The multi-branch fitting includes a tapping branch extending along a tapping branch axis that is substantially perpendicular to a pipe axis of the pressurized pipe, and a first access branch extending along a first access branch axis that is non-perpendicular relative to the pipe axis. At block 304, the method 300 includes hot-tapping the pressurized pipe via the tapping branch. At block 306, the method 300 includes inserting a tool into the pressurized pipe via the first access branch.

Block 308 illustrates an optional step of inserting the tool into the pressurized pipe via a second access branch. In this embodiment, the multi-branch fitting further includes a second access branch extending along a second access branch axis that is non-perpendicular relative to the pipe axis. Block 310 illustrates an optional step of, after hot-tapping the pressurized pipe, inserting a guide assembly at least partially into the pressurized pipe via the tapping branch. The optional steps illustrated at blocks 308 and 310 may be combined in the same method.

### INDUSTRIAL APPLICABILITY

The under-pressure tapping and access fitting and methods disclosed herein permit one or more tools to be inserted into a pipe carrying a fluid under pressure. For example, an inspection probe may be inserted into the pipe to collect inspection data while the fluid in the pipe remains pressurized, thereby providing useful data to installation and maintenance crews while installing and servicing a pipe network. In some instances, access to and inspection of smaller diameter pipes (e.g., 4 inches or less) may be difficult while under pressure. The inspection probe or other tool may not be easily inserted into the smaller diameter pipe (e.g., 4 inches or less) using existing hot tapping (i.e., under pressure) systems because the section of pipe is typically tapped at an axis perpendicular to the pipe axis (e.g., 90 degrees). Thus, the tool must make a 90 degree turn when inserted through the perpendicularly-orientated hole to be properly positioned within the interior of the pipe. However, there is not enough room to allow the tool to make this 90 degree turn in smaller diameter pipes.

Accordingly, the under-pressure tapping and access fitting allows for smaller diameter pipes to be tapped using a perpendicular tap to the pipe. Additionally, the under-pressure tapping and access fitting provides a non-perpendicular access for the tool to be properly inserted into the interior of the pipe while the pipe is under pressure. In some examples, the fitting includes multiple second or access branches to facilitate tool insertion into both directions of the pipe. Still further, a guide assembly may be provided to maintain spacing between a tether attached to the tool and sharp edges of the tapping hole, thereby to prevent damage to the tether.

While only certain embodiments have been set forth, alternatives and modifications will be apparent from the above description to those skilled in the art. These and other alternatives are considered equivalents and within the spirit and scope of this disclosure.

What is claimed is:

1. An under-pressure tapping and access assembly for use with a pressurized pipe, the under-pressure tapping and access assembly comprising:
a multi-branch portion sealingly coupled to an outer surface of the pressurized pipe;
a tapping branch of the multi-branch portion extending along a tapping branch axis that is substantially perpendicular relative to a pipe axis of the pressurized pipe;
a first access branch of the multi-branch portion extending along a first access branch axis that is non-perpendicular relative to the pipe axis; and
a tool sized for insertion through the first access branch.

2. The under-pressure tapping and access assembly of claim 1, wherein the multi-branch portion is configured such that the first access branch axis intersects with the tapping branch axis at an apex of the pressurized pipe.

3. The under-pressure tapping and access assembly of claim 1, further comprising a second access branch of the multi-branch portion extending along a second access branch axis that is non-perpendicular relative to the pipe axis.

4. The under-pressure tapping and access assembly of claim 1, in which the tool comprises an inspection probe configured to collect a set of inspection data from the pressurized pipe.

5. The under-pressure tapping and access assembly of claim 1, further comprising a tether coupled to the tool, and a tether guide assembly extending through the tapping branch and including a guide positioned adjacent an apex of the pressurized pipe and configured to engage the tether.

6. The under-pressure tapping and access assembly of claim 5, in which the tether guide assembly comprises an insertion rod extending through the tapping branch, and a yoke coupled to the insertion rod and sized for insertion through the tapping branch, wherein the yoke supports the guide and is at least partially disposed in the pressurized pipe.

7. The under-pressure tapping and access assembly of claim 6, in which the yoke comprises a base coupled to the insertion rod and two spaced tines extending away from the base, each of the tines defining a tine end configured to engage an inner surface of the pressurized pipe.

8. The under-pressure tapping and access assembly of claim 7, in which the guide comprises a roller rotatably supported on an axle extending between the tines of the yoke.

9. A kit for accessing and monitoring a fluid within a pressurized pipe, the kit comprising:
an under-pressure tapping and access assembly including:
a multi-branch portion sealingly coupled to an outer surface of the pressurized pipe;
a tapping branch of the multi-branch portion extending along a tapping branch axis that is substantially perpendicular relative to a pipe axis of the pressurized pipe; and
a first access branch of the multi-branch portion extending along a first access branch axis that is non-perpendicular relative to the pipe axis;
a first valve coupled to the tapping branch;
a second valve coupled to the first access branch; and
a tool sized for insertion into the pressurized pipe via the second valve and the first access branch.

10. The kit of claim 9, wherein the multi-branch portion is configured such that the first access branch axis intersects with the tapping branch axis at an apex of the pressurized pipe.

11. The kit of claim 9, in which the multi-branch portion further includes a second access branch extending along a second access branch axis that is non-perpendicular relative to the pipe axis.

12. The kit of claim 9, in which the tool comprises an inspection probe configured to collect a set of inspection data from the pressurized pipe.

13. The kit of claim 9, further comprising a tether coupled to the tool, and a tether guide assembly extending through the tapping branch and including a totable guide positioned adjacent an apex of the pressurized pipe and configured to engage the tether.

14. A method of tapping and accessing a pressurized pipe, the method comprising:
attaching a multi-branch fitting to a section of the pressurized pipe, the multi-branch fitting including a tapping branch extending along a tapping branch axis that is substantially perpendicular to a pipe axis of the pressurized pipe, and a first access branch extending along a first access branch axis that is non-perpendicular relative to the pipe axis;
hot-tapping the pressurized pipe via the tapping branch; and
inserting a tool into the pressurized pipe via the first access branch.

15. The method of claim 14, in which the multi-branch fitting further includes a second access branch extending along a second access branch axis that is non-perpendicular relative to the pipe axis, and in which the method further comprises inserting the tool into the pressurized pipe via the second access branch.

16. The method of claim 14, further comprising, after hot-tapping the pressurized pipe, inserting a guide assembly at least partially into the pressurized pipe via the tapping branch.

17. The method of claim 16, in which inserting the guide assembly includes advancing the guide assembly into the pressurized pipe until tine ends provided on a tine of the guide assembly engage an inner surface of the pressurized pipe.

18. The method of claim 17, in which the guide assembly includes a guide positioned to engage a tether coupled to the tool.

19. The method of claim 18, further comprising rotating the guide as the tether advances into or withdraws from the pressurized pipe.

20. The method of claim 14, in which the tool comprises an inspection probe configured to collect a set of inspection data, the method further comprising using the inspection probe collecting inspection data from the pressurized pipe.
